(19) United States
(12) Patent Application Publication
(10) Pub. No.: US 2014/0290774 A1
(43) Pub. Date: Oct. 2, 2014

(54) WATER FEEDING DEVICE AND FAUCET

(71) Applicant: Tien Ho CHUNG, Changhua County (TW)

(72) Inventor: Tien Ho CHUNG, Changhua County (TW)

(21) Appl. No.: 14/152,704

(22) Filed: Jan. 10, 2014

(30) Foreign Application Priority Data
Mar. 29, 2013 (TW) 102111433

(51) Int. Cl. E03C 1/04; F16L 57/00

(52) U.S. Cl. CPC E03C 1/04; F16L 57/00
USPC 137/801; 239/428.5; 138/103

(57) ABSTRACT

A water feeding device includes a metal shell and a water conduit. The metal shell includes a through hole. The water conduit is made of food grade material or non-metallic material, and is disposed in the through hole, wherein when water passes through the water conduit, the water doesn't contact of the metal shell.

### CROSS-REFERENCE TO RELATED APPLICATION

This application claims the benefit of Taiwan Patent Application No. 102111433, filed on Mar. 29, 2013, which is hereby incorporated by reference for all purposes as if fully set forth herein.

### BACKGROUND OF THE INVENTION

1. Field of Invention

The present invention relates to a water feeding device and more particularly to a water feeding device in that a water conduit is disposed in a metal shell.

2. Related Art

A faucet is a daily necessity product and such product structure hasn't changed magnificently for years. The faucet is commonly made of a metal alloy, such as brass alloy and zinc alloy. For fear that the stability of metal alloy can decide the oxidation of the zinc alloyed faucet, the brass alloy is usually chosen for the pipeline set where water passes. The zinc alloy is applied for external appearance.

Brass alloy is quite durable. Aesthetic qualities of products are appreciated in European markets, and hence full-brass alloyed faucets are widely used. However, the brass alloyed contains copper, zinc and lead. If the brass alloyed faucets doesn't be used over a long period of time, they will start to generate green copper corrosion on an inner wall thereof, and the lead can release into the tap water. High amounts of the lead in the tap water will cause lead intoxication, which seriously damages drinkers' intelligence growth and health.

Accordingly, a need remains for a water feeding device to solve the foregoing problems.

### SUMMARY OF THE INVENTION

The objective of the present invention to provide to a water feeding device and a faucet, wherein the toxic substances released from the metal shell into the water can be stopped.

To achieve the foregoing objective, the present invention provides a water feeding device including a metal shell and a water conduit. The metal shell includes a through hole. The water conduit is made of food grade material or non-metallic material, and is disposed in the through hole, wherein when water passes through the water conduit, the water doesn't contact of the metal shell.

To achieve the foregoing objective, the present invention further provides a faucet, including the above-mentioned water feeding device and a switch. The switch is adapted for controlling whether water flowing through the water conduit.

According to the water feeding device and the faucet of the present invention having the water conduit, when water flows through the water conduit, and the water doesn't contact with the metal shell, the toxic substances released from the metal shell leach into the water can be stopped. Also, the water conduit made of food grade material can ensure consumers healthy and safe when the consumers drink potable water.

To make the aforementioned and other objects, features and advantages of the present invention clearer, detailed illustration is provided in the following with reference to the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a combined perspective view of the present invention.

FIG. 2 is an exploded perspective view of a water feeding device of the present invention.

FIG. 3a is a cross-sectional view of a water feeding device of the present invention.

FIG. 3b is an enlarged view of portion A in FIG. 3a.

FIG. 3c is an enlarged view of portion B in FIG. 3a.

FIG. 4 is a perspective view of a water faucet of the present invention.

### DETAILED DESCRIPTION OF THE INVENTION

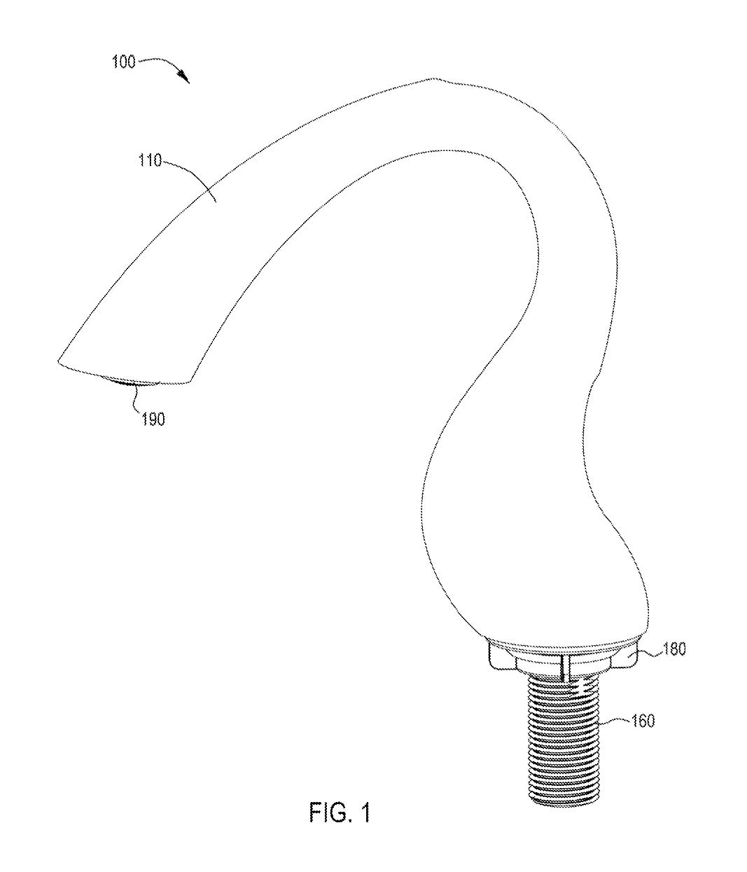

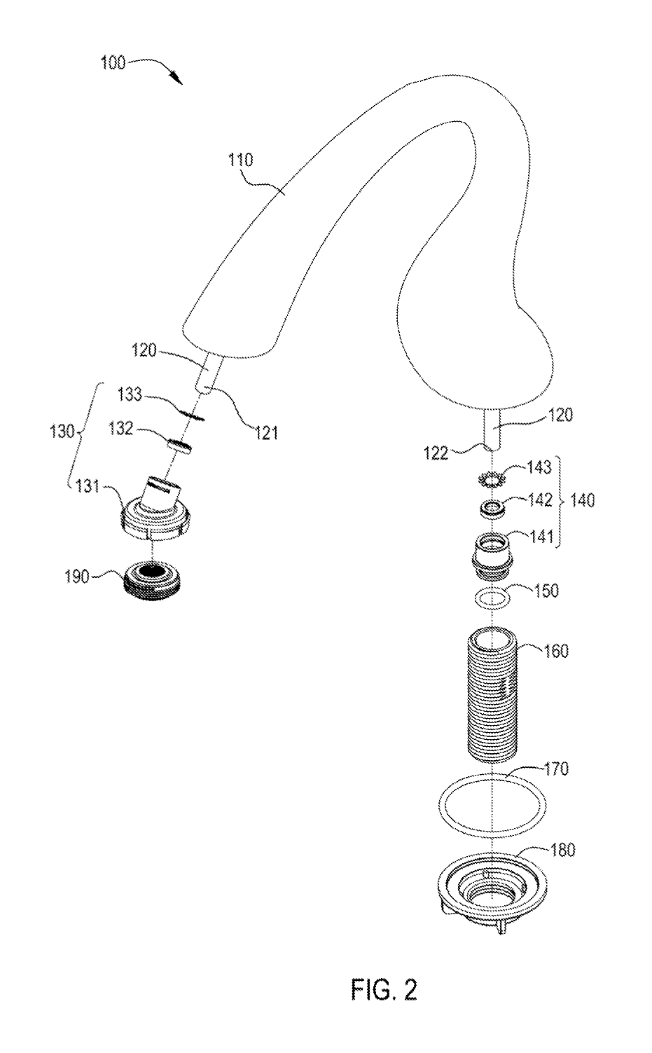

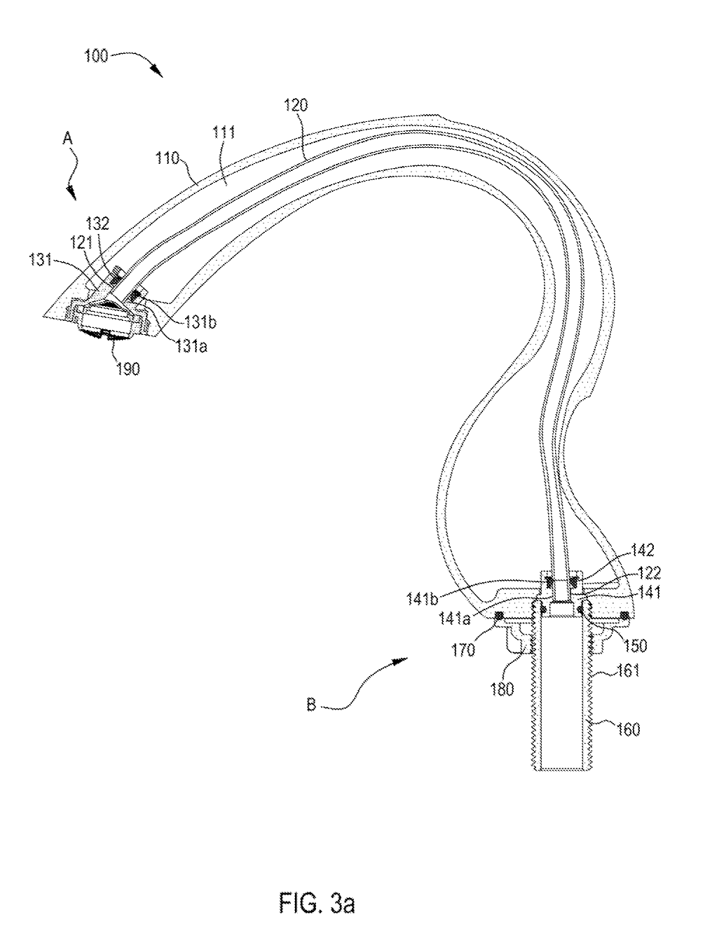

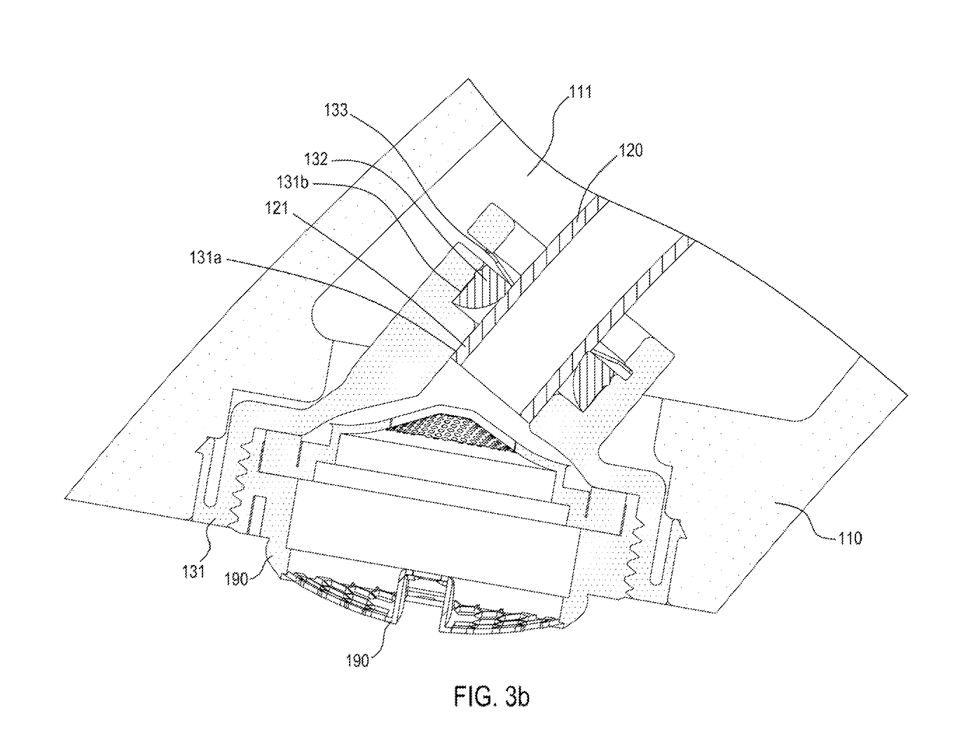

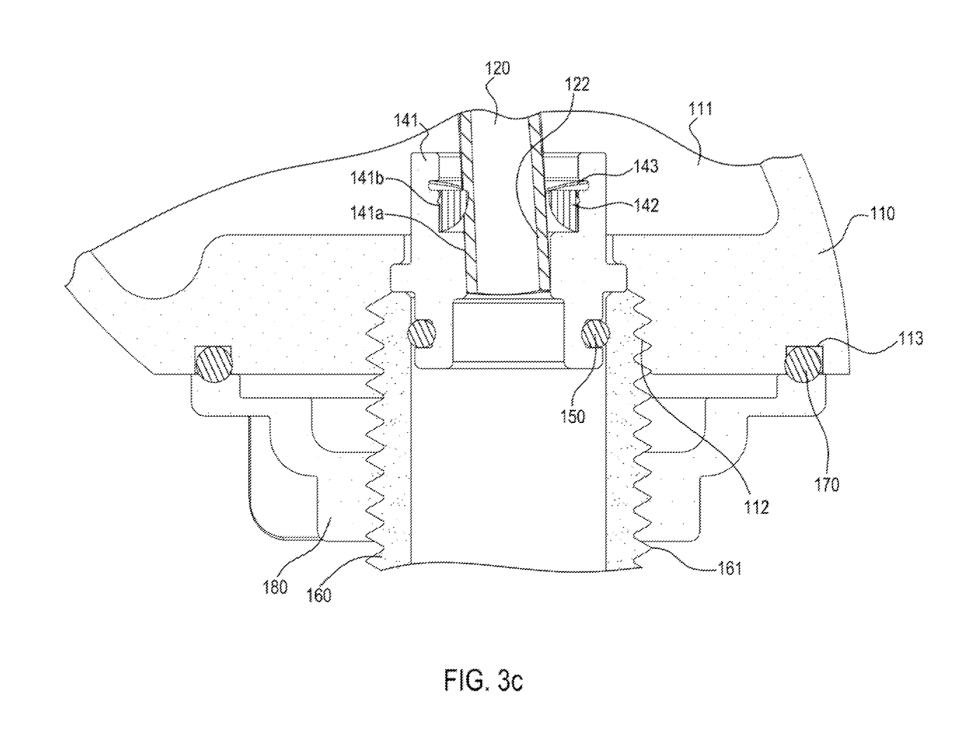

Please refer to FIG. 1, FIG. 2 and FIG. 3a simultaneously. FIG. 1 is a combined perspective view of a water feeding device of the present invention. FIG. 2 is an exploded perspective view of a water feeding device of the present invention. FIG. 3a is a cross-sectional view of a water feeding device of the present invention. The water feeding device 100 includes a metal shell 110 and a water conduit 120.

The metal shell 110 includes a through hole 111. The metal shell 110 can be made of a brass alloy, and the bass alloy contains copper, zinc and lead. The water conduit 120 can be made of a food grade material or a non-metallic material, which is disposed within the through hole 111, wherein water flows through the water conduit 120 and doesn't contact with the metal shell 110. The food grade material is approved safe by U.S. Food and Drug Administration (FDA), such as stainless steel, Silicone, and Polytetrafluoroethene (PTFE) (i.e., trademark: TEFLON). Or, the food grade material of water conduit 120 is a food grade plastic, which is High Density Polyethylene (HDPE), Polyethylene Terephthalate (PETG), Polyethylene (PE) or Polypropylene (PP). The water conduit 120 has a first end 121 and a second end 122. Non-metallic material refers to non-zinc or non-brass alloyed material. Also, the non-metallic material of the water conduit can be Silicone. The non-metallic material of the water conduit can be Polytetrafluoroethene (PTFE). The non-metallic material of the water conduit can be a food grade plastic, which is High Density Polyethylene (HDPE), Polyethylene Terephthalate (PETG), Polyethylene (PE) or Polypropylene (PP).

The water feeding device 100 can further include an aerator quick connector 130, a water-conduit quick connector 140, an O-ring 150, a threaded pipe 160, a rubber ring 170, a nut 180 and an aerator 190. Please refer to FIG. 3b simultaneously, it is an enlarged view of portion A in FIG. 3a. The first end 121 of the water conduit 120 is connected to the aerator 190 by the aerator quick connector 130, and the aerator quick connector 130 and the aerator 190 can be mounted to each other by a screwed manner The aerator 190 mixes air with water flowing out of the first end 121 of water conduit 120 so as to produce mass quantities of bubbles, and then the combination of water and air in tiny bubbles are discharged to reduce water consumption. The aerator quick connector 130 includes a connector body 131, a sealing rubber ring 132 and a tooth-shaped washer 133. The connector body 131 includes a through hole 131a and a receiving groove 131b, and the through hole 131a is communicated to the receiving groove 131b. Firstly, the sealing rubber ring 132 is disposed within the receiving groove 131b. Then, the tooth-shaped washer 133 is disposed within the receiving groove 131b and is stacked above the sealing rubber ring 132. The first end 121 of the water conduit 120 passes through the tooth-shaped washer 133, the sealing rubber ring 132 and the through hole 131a of the connector body 131. The tooth-shaped washer 133 can be adapted to mount the first end 121 of the water conduit 120 within the through hole 131a of the aerator quick connector 130, whereby the first end 121 of the water conduit 120 is uneasily escaped from the through hole 131a of the aerator quick connector 130. The sealing rubber ring 132 can prevent water from flowing into the through hole 111 of the metal shell 110, and also increase the friction between the first end 121 of the water conduit 120 and the sealing rubber ring 132.

Please refer to FIG. 3c simultaneously, it is an enlarged view of portion B in FIG. 3a. The second end 122 of the water conduit 120 is connected to a water-conduit quick connector 140. The water-conduit quick connector 140 includes a connector body 141, a sealing rubber ring 142 and a tooth-shaped washer 143. The connector body 141 includes a through hole 141a and a receiving groove 141b, and the through hole 141a is communicated to the receiving groove 141b. Firstly, the sealing rubber ring 142 is disposed within the holding groove 141b. Then, the tooth-shaped washer 143 is disposed within the holding groove 141b and is stacked above the sealing rubber ring 142. The second end 122 of the water conduit 120 passes through the tooth-shaped washer 143, the sealing rubber ring 142 and the through hole 141a of the connector body 141. The tooth-shaped washer 143 is adapted to mount the second end 122 of the water conduit 120 within the through hole 141a of the water-conduit quick connector 140, whereby the second end 122 is uneasily escaped from the through hole 141a of the water-conduit quick connector 130. The sealing rubber ring 142 can prevent water from flowing into the through hole 111 of the metal shell 110, and also increase the friction between the second end 122 of the water conduit 120 and the sealing rubber ring 142.

The O-ring 150 is put around water-conduit quick connector 140 and then the threaded pipe 160 is further put around water-conduit quick connector 140, whereby the O-ring 150 is located between the water-conduit quick connector 140 and the threaded pipe 160. The threaded pipe 160 has a screw thread 161 at the outer side thereof, and the through hole 111 of metal shell 110 also has a screw thread 112 at one end thereof, wherein the screw thread 161 of the threaded pipe 160 and the screw thread 112 of the metal shell 110 are mounted to each other by a screwed manner. When the threaded pipe 160 is full of water, the O-ring 150 is adapted to prevent water from entering the through hole 111 of the metal shell 110 so as to keep the through hole 111 of the metal shell 110 dry. The rubber ring 170 is put over the threaded pipe 160 and is mounted on a bottom surface of the metal shell 110. The nut 180 moves along the screw thread 161 of the threaded pipe 160 for mounting the threaded pipe 160, until the nut 180 reaches the rubber ring 170 and is mounted outside the threaded pipe 160. The nut 180 can be plastic butterfly nut.

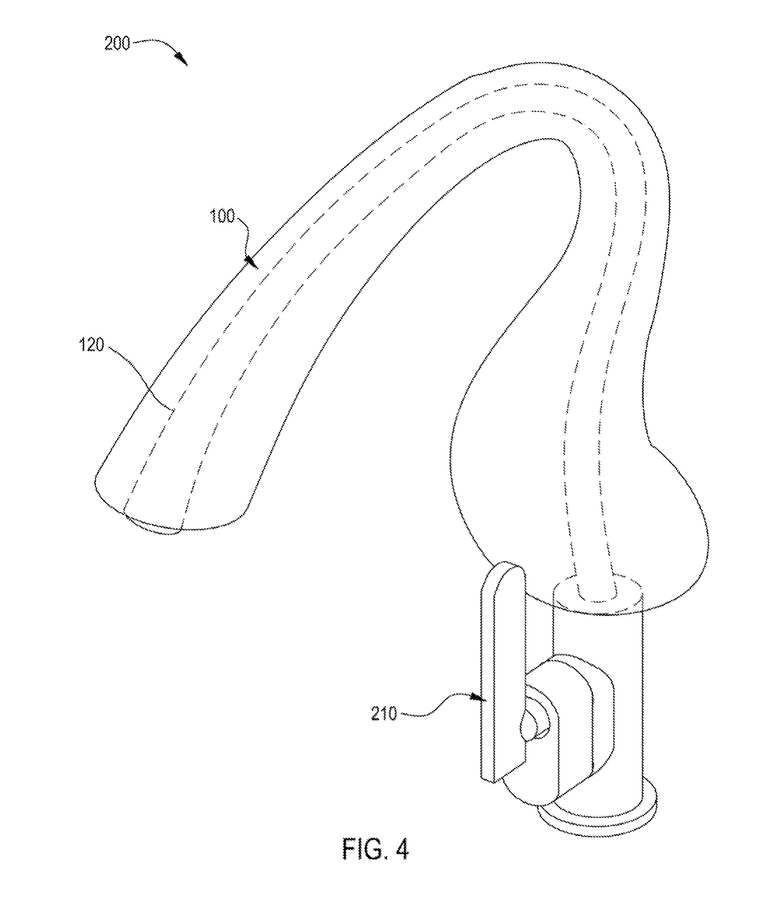

FIG. 4 is a perspective view of a water faucet of the present invention. The faucet 200 includes a water feeding device 100 and a switch 210. The water feeding device 100 are the foregoing water feeding device 100 shown in FIG. 1 to FIG. 3c. The switch 210 controls whether water passes through the water conduit 120. The switch 210 can be a manual switch or an automatic switch. The manual switch controls the volume of water discharge by rotating or tumbling manner (shown in FIG. 4). The automatic switch controls whether water flows into the water conduit 120 by a sensing manner, such as infrared sensing, temperature sensing or acoustic sensing manner.

According to the water feeding device and the faucet of the present invention having the water conduit, when water flows through the water conduit, and the water doesn't contact with the metal shell, the toxic substances released from the metal shell into the water can be stopped. Also, the water conduit made of food grade material can ensure consumers healthy and safe when the consumers drink potable water.

The foregoing is considered as illustrative only of the implementation manners or embodiments of the technical solutions adopted by the present invention to solve the problems and it's not desired to limit the scope of the invention. Accordingly, all suitable modifications and equivalents may be resorted to, falling within the scope of the invention.

What is claimed is:

1. A water feeding device, comprising:
a metal shell comprising a through hole; and
a water conduit, made of a food grade material and disposed in the through hole, wherein when water flows through the water conduit, and the water doesn't contact with the metal shell.

2. The water feeding device of claim 1 wherein a first end of the water conduit is connected to an aerator by an aerator quick connector, and the aerator quick connector comprises:
a first connector body, comprising a first through hole and a first receiving groove communicated with the first through hole;
a first sealing rubber ring, disposed within the first receiving groove; and
a first tooth-shaped washer, disposed within the first receiving groove and stacked above the first sealing rubber ring, wherein the first end of the water conduit passing through the first tooth-shaped washer, the first sealing rubber ring and the first through hole of the first connector body, and the first tooth-shaped washer is adapted to mount the first end of the water conduit within the first through hole of the aerator quick connector.

3. The water feeding device of claim 1 wherein a second end of the water conduit is connected to a water-conduit quick connector, and the water-conduit quick connector comprises:
a second connector body, comprising a second through hole and a second receiving groove communicated with the second through hole;
a second sealing rubber ring, disposed within the second receiving groove; and
a second tooth-shaped washer, disposed within the second receiving groove and stacked above the second sealing rubber ring, wherein the second end of the water conduit passing through the second tooth-shaped washer, the second sealing rubber ring and the second through hole of the second connector body, and the second tooth-shaped washer is adapted to mount the second end of the water conduit within the second through hole of the water-conduit quick connector.

4. The water feeding device of claim 1 wherein the food grade material of the water conduit is stainless steel.

5. The water feeding device of claim 1 wherein the food grade material of the water conduit is Silicone.

6. The water feeding device of claim 1 wherein the food grade material of the water conduit is Polytetrafluoroethene (PTFE).

7. The water feeding device of claim 1 wherein the food grade material of the water conduit is a food grade plastic, which is High Density Polyethylene (HDPE), Polyethylene Terephthalate (PETG), Polyethylene (PE) or Polypropylene (PP).

8. The water feeding device of claim 1 wherein the metal shell is made of a brass alloy.

9. A water feeding device comprising:
a metal shell comprising a through hole; and
a water conduit made of non-metallic material and disposed in the through hole, wherein when water flows through the water conduit, the water doesn't contact with the metal shell.

10. The water feeding device of claim 9 wherein the non-metallic material of the water conduit is Silicone.

11. The water feeding device of claim 9 wherein the non-metallic material of the water conduit is Polytetrafluoroethene (PTFE).

12. The water feeding device of claim 9 wherein the non-metallic material of the water conduit is a food grade plastic, which is High Density Polyethylene (HDPE), Polyethylene Terephthalate (PETG), Polyethylene (PE) or Polypropylene (PP).

13. A faucet, comprising:
the water feeding device of claim 1; and
a switch for controlling whether water flowing through the water conduit.
